(19) United States
(12) Patent Application Publication
(10) Pub. No.: US 2022/0086129 A1
(43) Pub. Date: Mar. 17, 2022

(54) ESTABLISHING A PROTECTED DATA COMMUNICATION CONNECTION BETWEEN A CONTROLLER OF A PASSENGER TRANSPORT SYSTEM AND A MOBILE DEVICE

(71) Applicant: Inventio AG, Hergiswil (CH)

(72) Inventor: Claudio Colombano, Beckenried (CH)

(21) Appl. No.: 17/309,664

(22) PCT Filed: Dec. 18, 2019
(86) PCT No.: PCT/EP2019/085864

§ 371 Date: Jun. 14, 2021

(30) Foreign Application Priority Data
Dec. 21, 2018 (EP) 18215567.1

(51) Int. Cl. H04L 9/08; H04W 12/03; H04W 4/80

(52) U.S. Cl. CPC H04L 63/0442; H04L 9/0869; H04W 12/03; H04L 9/088; H04L 9/0827; H04W 4/80; H04L 63/18; H04L 9/0877

(57) ABSTRACT

A method establishing a protected data communication connection between a passenger transport system controller and a mobile device includes steps of: establishing an unprotected data communication connection between controller and mobile device; establishing a first protected data communication connection between controller and a common external computer and a second protected data communication connection between mobile device and computer; transmitting a token via the unprotected connection; transmitting the token to computer via both the first and the second protected connections; generating in computer two key pairs each including a public key and a private key; transmitting first key pair private key and second key pair public key to controller and transmitting second key pair private key and first key pair public key to mobile device; converting the unprotected connection into the protected connection by encrypting the data to be transmitted using the key pairs.

### FIELD

The present invention relates to a method by means of which a protected data communication connection can be established between a controller of a passenger transport system and a mobile device. The invention also relates to devices and computer program products which are configured to carry out or control the method and to computer-readable media with such computer program products stored thereon.

### BACKGROUND

Passenger transport systems such as elevators, moving walkways or escalators are used to transport people within buildings or structures and are permanently installed for this purpose. A passenger transport system has various stationary components and displaceable components, the operation of which is usually controlled and/or coordinated by a controller. For example, the controller of an elevator controls the manner in which a drive machine must be operated in order to move an elevator car to certain floors in response to call requests. In the case of a moving walkway or an escalator, a controller can, among other things, control the operation of a drive machine in order to meet operating requirements that vary over time, for example.

The controller must meet high safety requirements. For example, it must be ensured that the controller always controls the operation of the passenger transport system in such a way that the passengers and/or the integrity of the passenger transport system are not endangered. It must also be ensured that the controller itself cannot be manipulated without authorization.

For example, as part of maintenance measures or repair measures for already existing and operated passenger transport systems or for commissioning a passenger transport system before it is put into operation, it may be necessary to enter data into and/or read out data from the controller of the passenger transport system. For example, it may be necessary to input updated operating parameters and/or control parameters into the controller and/or to read out parameters stored in the controller. It may also be necessary to update software, in particular firmware, of the controller. However, it must be ensured in particular that data in the controller may only be changed by authorized parties. It should also only be possible to read out data from the controller after prior authorization.

Conventionally, controllers of passenger transport systems have their own man-machine interface, such as a display and several input keys, via which data can be entered and read out manually by a technician. However, this can be very time-consuming and/or complex, and therefore both the time required for this can be considerable and the risk of errors occurring in the process can be high.

As an alternative, approaches have been developed in which data can be transmitted to the controller of a passenger transport system or read out therefrom by means of a mobile device. The mobile device can be a portable device such as a smartphone, laptop, tablet or the like, which has its own processor, its own data memory and its own man-machine interface. The mobile device can exchange data with the controller via a line-based or wireless data communication connection.

In order to ensure that data can only be entered or read out by an authorized party, it may be required, for example, that a technician operating the mobile device must authorize himself in advance, for example by entering a password or a PIN. Furthermore, it must be ensured that the data transmission via the data communication connection also takes place securely and that no data can be manipulated or intercepted.

However, it has been recognized that the effort that has to be made in order to establish a protected data communication connection between the controller of a passenger transport system and a mobile device can be considerable.

### SUMMARY

Among other things, there may be a need for a method by means of which a protected data communication connection can be established between a controller of a passenger transport system and a mobile device relatively easily, securely and/or with minimal logistical effort. Furthermore, there may be a need for a device arrangement by means of which a passenger transport system can be serviced, as well as for a controller of a passenger transport system, which are configured to carry out or control such a method. In addition, there may be a need for a corresponding computer program product and for a computer-readable medium storing such a computer program product.

Such a need can be met by a subject matter according to any of the advantageous embodiments defined in the following description.

According to a first aspect of the invention, a method is proposed for establishing a protected data communication connection between a controller of a passenger transport system and a mobile device. Both the controller and the mobile device are configured to establish an initially unprotected data communication connection with one another and to establish protected data communication connections with a common external computer. The method comprises at least the following method steps, preferably, but not necessarily, in the order specified:

establishing an unprotected data communication connection between the controller and the mobile device;

establishing a first protected data communication connection between the controller and the common external computer and establishing a second protected data communication connection between the mobile device and the common external computer;

transmitting a token between the controller and the mobile device via the unprotected data communication connection;

the controller transmitting the token to the common external computer via the first protected data communication connection and the mobile device transmitting the token to the common external computer via the second protected data communication connection;

generating a first and a second key pair each comprising a public key and a private key in the common external computer;

the common external computer transmitting at least the private key of the first key pair and the public key of the second key pair to the controller and the common external computer transmitting at least the private key of the second key pair and the public key of the first key pair to the mobile device; and

converting the unprotected data communication connection between the controller and the mobile device into a protected data communication connection by encrypting the data to be transmitted using the key pairs.

According to a second aspect of the invention, a device arrangement for servicing a passenger transport system is proposed. The device arrangement comprises a controller of the passenger transport system, a mobile device, and a common external computer. The device arrangement is configured to carry out or control a method according to an embodiment of the first aspect of the invention.

According to a third aspect of the invention, a controller of a passenger transport system is proposed which is configured to carry out or control a method according to an embodiment of the first aspect of the invention in cooperation with a mobile device and a common external computer.

According to a fourth aspect of the invention, a computer program product having computer-readable instructions is proposed, which instructions, when executed on one or more processors in a device arrangement according to an embodiment of the second aspect of the invention, instruct to carry out or control the method according to an embodiment of the first aspect of the invention.

According to a fifth aspect of the invention, a computer program product having computer-readable instructions is proposed, which instructions, when executed on one or more processors in a controller according to an embodiment of the third aspect of the invention, instruct to carry out or control the method according to an embodiment of the first aspect of the invention in cooperation with a mobile device and a common external computer.

According to a sixth aspect of the invention, a computer-readable medium having a computer program product stored thereon according to an embodiment of the fourth or fifth aspect of the invention is proposed.

Possible features and advantages of embodiments of the invention may be considered, inter alia and without limiting the invention, to be dependent upon the concepts and findings described below.

As already indicated in the introduction, data can be entered into or read out from a controller of a passenger transport system, for example as part of maintenance measures or during initial commissioning, by a data communication connection being established between the controller and an external mobile device. The mobile device can then serve as an external man-machine interface, for example to have data entered by a technician and to then forward this data to the controller via the data communication connection or to display data read out from the controller to the technician. Additionally or alternatively, the mobile device can also obtain data from other sources, for example from an external database, from the Internet or from a data cloud specially provided for this purpose, and then transmit the data to the controller via the data communication connection. Conversely, data from the controller can also be forwarded to other devices, in particular to a database or a data cloud, via the mobile device. In this way, for example, targeted configuration and/or updating of stored parameters or data and/or updating of software in the controller can be simplified.

However, it must be ensured here that the data can be entered and/or read out only by an authorized party, i.e. by a technician and/or devices authorized for this purpose. After the technician or the device has previously authenticated itself, for example by entering or transmitting an authentication code, data can be transmitted between the controller and the mobile device via the data communication connection.

If no special measures are taken, however, such data transmission is not secure. In other words, an attacker could potentially send data to the controller himself via the data communication connection and thus manipulate it without authorization. Conversely, the attacker could also intercept data read out from the controller.

In order to be able to avoid this, the data communication connection can be protected, by the data that is to be transmitted via this connection being encrypted, by means of, for example, symmetrical cryptography keys or asymmetrical cryptography keys, before said data is transmitted to a target device via the data communication connection, and the encrypted data then being decrypted again in the target device.

One problem with the above-mentioned method can be that it does not provide flexible security. As soon as, for example, a new password or a new key is introduced into a new version of the control software, the corresponding passwords and keys must be changed in all mobile devices that are used to maintain this control. This is logistically problematic. It actually requires backward compatibility in key management, which goes against a primary purpose of securing, and possibly duplicating the same key on all installations, which can also increase the likelihood of being compromised, potentially with effects on the entire portfolio.

It was therefore recognized that, if possible, every application for encrypting data to be transmitted and thus for creating a protected data communication connection should have a different key pair. This key pair should preferably be able to be generated without complex logistical efforts and/or have a time-limited period of validity and/or be independent of different software versions.

Embodiments of the method presented herein for establishing a protected data communication connection between a controller of a passenger transport system and a mobile device address the above-mentioned problems or deficits in conventional approaches.

A data communication connection between the controller of the passenger transport system and an external mobile device should be designed to be protected in such a way that data transmitted via this connection is always transferred in encrypted form so that it cannot be manipulated or intercepted by attacking third parties.

It is assumed here that both the controller of the passenger transport system and the mobile device can each communicate with a common external computer via a previously established protected data communication connection. This common external computer can be a server or a data cloud that is located outside the passenger transport system and preferably also outside a building that houses the passenger transport system. For example, the common external computer can be operated by a manufacturer of the passenger transport system or by a service provider. The controller and the mobile device can communicate with this external computer in a wired or wireless manner, for example via a network such as the Internet, with communication content between two communication partners always being transmitted in encrypted form, for example with end-to-end encryption. Suitable secure communication protocols can be used for data communication.

It is also assumed that the controller of the passenger transport system and the mobile device can establish an unprotected data communication connection with one another. Both components can exchange data via this unprotected data communication connection, but this data is transmitted unencrypted. For example, the controller and the mobile device can communicate with one another via a data cable or a wireless connection.

In the method presented herein, the controller and the mobile device first establish the unprotected data communication connection between the two components.

Both components can then exchange a so-called token via this unprotected data communication connection. The token can be data content, i.e. a type of code, for example, which is provided by one of the components and can then be transmitted to the other component. For example, the mobile device can provide the token and transmit it to the controller, for example after the mobile device has been requested to do so by a technician. Conversely, the controller can also provide a token and transmit it to the mobile device as soon as said device is ready to receive this token. For example, the token can be generated spontaneously in one of the components or it can have been stored therein in advance. The token should be unique or at least very likely to be unique, i.e. each controller and each mobile device should provide a unique token, which if possible is not provided by any other controller or mobile device, either unintentionally or deliberately. For example, the token can be generated randomly.

Simultaneously with the establishment of the unprotected data communication connection between the control device and the mobile device or alternatively also before or shortly after the establishment of this unprotected data communication connection, both the control device and the mobile device each also establish a protected data communication connection with the common external computer. Both the control device and the mobile device can then forward the provided or received token to the external computer via its protected data communication connection.

The external computer can then generate two so-called key pairs, which are designed in such a way that data to be transmitted thereby can first be encrypted in a common encryption method and then decrypted again. Each key pair comprises a public key, by means of which the data can be encrypted, and a private key, by means of which the data can then be decrypted again.

The external computer then transmits a first of these key pairs, or at least the private key of this key pair, back to the controller via the first protected data communication connection. The external computer also transmits the public key of the second key pair to the controller. In a similar way, the external computer also transmits the second of these key pairs, or at least the private key of this key pair, back to the mobile device via the second protected data communication connection and also transmits the public key of the first key pair to the mobile device.

Both the controller of the passenger transport system and the mobile device then each have both their own private key and the public key of the other communication partner. Using the key pairs, the controller and the mobile device can then establish the desired protected data communication connection between them by all the data to be transmitted being encrypted with the communication partner's public key, being transmitted via the data communication connection and then being decrypted by the communication partner using its private key.

Accordingly, after the key pairs have been distributed, the communication partners can, for example, negotiate a symmetrical key for a communication process (i.e. a “session key”) and thus exchange encrypted and preferably digitally signed data packets or messages. This allows the controller and the mobile device to communicate with one another in a protected manner by using the temporary key for the communication process.

According to an embodiment, the external common computer can generate the two key pairs in response to the transmission of the token.

In other words, receiving the token can cause, i.e. trigger, the external common computer to generate the two key pairs. In particular, the external computer can generate the key pairs only when it has received the same token both from the control device and from the mobile device. The generated key pairs can then preferably be transmitted immediately to the controller or to the mobile device via the first or second secure data communication connection, respectively.

Accordingly, key pairs do not need to be constantly generated in the external common computer which are then transmitted when required to a pair of communication partners, i.e. a controller and a mobile device, which want to communicate and announce this by transmitting the token, for which purpose a high computing power would be necessary in the external computer. On the other hand, key pairs do not need to be generated in advance and then stored in the external common computer until they are required, which could increase a risk that such key pairs would be spied on in advance. Instead, a key pair can be generated exactly when it is required by a pair of communication partners and requested by transmitting the token.

According to an embodiment, the external common computer can generate the two key pairs randomly.

In other words, the external common computer can be configured to generate a key pair randomly each time a key pair is required, independently of previously or subsequently generated key pairs. Assuming that there is a very high number of possible key pairs, this can be used to virtually ensure that the same key pair is not generated twice.

This allows different pairs of communication partners to communicate with one another using different key pairs. Even in the event that a key pair should become public, for example because it was spied on, there are no negative consequences for other pairs of communication partners, i.e. the secure data communication between another controller and another mobile device would not be endangered.

According to an embodiment, the key pairs have a defined expiration time, after which they can no longer be used for the protected data communication connection.

In other words, the key pairs can be designed in such a way that they lose their functionality after a predefined expiration time, so that protected data transmission using a key pair of which the expiration time has been reached is no longer possible.

Typically, a mobile device needs to be able to communicate with the controller of a passenger transport system only for a certain period of time, for example during a maintenance process. This period of time can be a few minutes, a few hours, or a few days, for example. The expiration time of key pairs used for protected data communication with this mobile device can therefore be such that, after the mobile device no longer has to communicate with the control of the passenger transport system, the key pairs used automatically lose their validity or functionality. In this way, misuse of key pairs after they are no longer required for their actual purpose can be avoided.

According to an embodiment, the common external computer can be part of a data cloud which is hosted by a company in charge of the passenger transport system.

In other words, for example, a manufacturer of the passenger transport system or a service provider in charge of the passenger transport system can operate a data cloud. This data cloud can comprise one or more computers or servers, including the common external computer mentioned herein. The controller of the supervised passenger transport system can, for example, establish a protected data communication connection with this data cloud via a data line. The mobile device can also establish a protected data communication connection with the data cloud, for example via a suitable encrypted Internet connection. The data cloud can be part of an IT infrastructure of the company in charge of the passenger transport system and can therefore be under its influence, and the IT protection mechanisms implemented there can be protected.

As a result, the common external computer can be used, for example, to specify rules according to which the first and second protected data communication connections are to be established. This can be used, for example, to also be able to specify how a mobile device must establish the second protected data communication connection in order to then be able to transmit the token via said connection. Even in the case, which is likely to occur frequently, that the mobile device itself is not subject to the influence of the company in charge of the passenger transport system, it can thus be ensured that this mobile device must adhere to certain rules. For example, it can be specified that the mobile device or a technician using the mobile device must authenticate itself/himself before the second protected data communication connection can be established.

Embodiments of the method presented herein for establishing a protected data communication connection between a controller of a passenger transport system and a mobile device can address, inter alia, the following problems or difficulties:

Keys that are to be used in encryption for data transmission do not need to be generated and then stored at the time of production of a controller or a mobile device. In this way, inter alia, logistical problems can be avoided which can be associated with such generation and storage of a key at such an early point in time. For example, it can be avoided that a key has to be generated and stored at a point in time at which it is not yet known which mobile device should actually be able to communicate with which controller. Accordingly, there is no need to duplicate keys. In addition, this can avoid problems that can arise because keys that have been generated and stored can hardly be recalled afterwards or their validity can hardly be revoked afterwards.

Since new key pairs are preferably generated every time a controller and a mobile device want to establish a protected data communication connection and send the token to the common external computer for this purpose, it should generally not be the case that two different pairs of communication partners have the same key pairs. Even if a key pair should become known, for example because a pair of communication partners was spied on or intercepted (hacked), this generally does not compromise other pairs of communication partners.

The fact that a key pair can optionally be assigned a defined expiration time can further reduce potential damage that could be caused by hacking a pair of communication partners.

There are generally no compatibility issues; security is guaranteed by a joint distribution of security keys that is not carried out in different places. In other words, the manufacturer's data cloud in which the external common computer is included does not perceive the versions of the controller or of the mobile device, for example.

The security of the overall system depends mainly on the IT security of the company that, among other things, produces the controller of the passenger transport system, operates the external common computer and/or supplies software for the mobile device and is thus responsible for the establishment of the protected first and second data communication connections between the controller or the mobile device on the one hand and the external common computer on the other hand. Such company-wide IT security can be better organized, updated, and monitored. A gap in a subunit thereof requires the gap to be closed (patching) at only one point.

The device arrangement according to the second aspect of the invention, which can be used to maintain a passenger transport system, is intended to comprise the controller of the passenger transport system, a separate mobile device and the common external computer. Each of the communication partners mentioned can be configured to carry out parts of the method steps of the method described above for establishing the protected data communication connection, so that all the communication partners then carry out or control the entire method together.

In particular, the controller of the passenger transport system according to the third aspect of the invention can be configured to be able to carry out or control the entire method together with the mobile device and the common external computer.

For this purpose, the controller can, among other things, have an interface via which the first data communication connection to the common external computer can be established. Furthermore, the controller can have a further interface via which the initially unprotected data communication connection to the mobile device can be established. The interfaces can be line-based or wireless. The controller can have one or more processors and suitable data memories in order to be able to intermediately store data to be transmitted and/or to be able to encrypt said data before transmission or to be able to decrypt transmitted data and optionally intermediately store said data.

In a similar way, the mobile device can, among other things, have an interface via which the second data communication connection to the common external computer can be established, as well as a further interface via which the initially unprotected data communication connection with the controller can be established. In a manner analogous to the controller, the interfaces can also be line-based or wireless and one or more processors and data memories can be provided for implementing corresponding functions.

The common external computer can have at least one or two interfaces via which the first and second protected data communication connections can be established. Furthermore, the external computer can have one or more processors and data memories by means of which it can, among other things, recognize and/or analyze received tokens and generate key pairs. The computer can also have a random generator, so that the key pairs can be generated randomly.

Individual communication partners or each of the communication partners, i.e. the controller, the mobile device and/or the common external computer, can be programmable. A computer program product can consist of several parts; each part is able to run on one of the communication partners and there, by means of appropriate instructions, can cause the particular communication partner to carry out its part of the method described herein. Overall, the method described herein can thus be implemented with the various communication partners by means of the computer program product. The computer program product can be formulated in any computer language.

The computer program product can be stored on any computer-readable medium. For example, a portable computer-readable medium such as a flash memory, a CD, a DVD or the like can be used. Alternatively, a stationary computer-readable medium such as a computer, server or a data cloud can be provided to store the computer program product so that it can be downloaded therefrom, for example via a network such as the Internet.

It should be noted that some of the possible features and advantages of the invention are described herein with reference to different embodiments of the method for establishing a protected data communication connection on the one hand and of the device arrangement with corresponding communication partners that can be used for this purpose on the other. A person skilled in the art recognizes that the features can be combined, adapted or replaced as appropriate in order to arrive at further embodiments of the invention.

Embodiments of the invention will be described below with reference to the accompanying drawings, with neither the drawings nor the description being intended to be interpreted as limiting the invention.

### DESCRIPTION OF THE DRAWINGS

FIG. 1 shows a device arrangement by means of which a method according to an embodiment of the present invention can be implemented.

The drawing is merely schematic and is not to scale.

### DETAILED DESCRIPTION

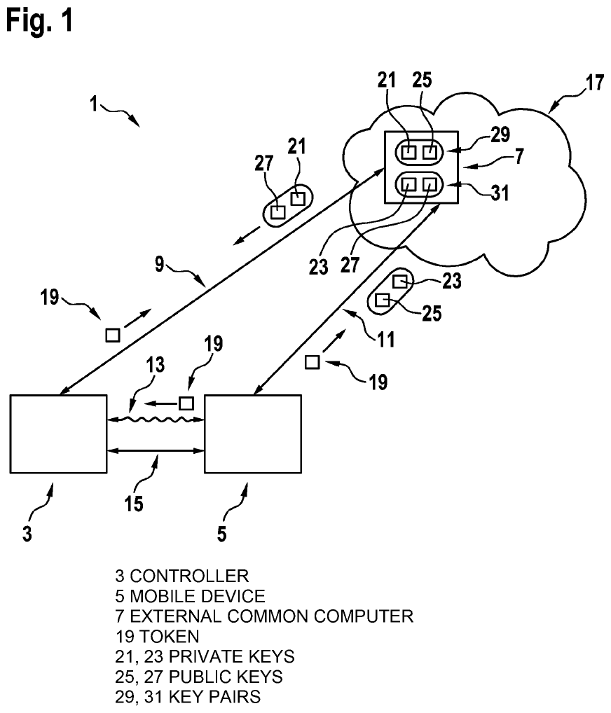

FIG. 1 shows a device arrangement 1 according to an embodiment of the present invention. The device arrangement 1 comprises a controller 3 of a passenger transport system, a mobile device 5, and an external common computer 7, which computer can be part of a data cloud 17. The controller 3 has the option of communicating with the external common computer 7 via a first protected data communication connection 9. In a similar way, the mobile device 5 can establish a second protected data communication connection 11 with the external computer 7, via which data can then be exchanged. For example, the mobile device 5 can communicate with the external computer 7 via a protected Internet connection.

A wired or wireless data communication connection 13 can be established between the mobile device 5 and the controller 3 without any problems. However, this is initially unprotected, i.e. data is transmitted unencrypted and therefore without any guarantee of authentication.

Using the method presented herein, this unprotected data communication connection 13 can be modified into a protected data communication connection 15 between the mobile device 5 and the controller 3.

A process is described below by way of example in which the protected data communication connection 15 is established.

A technician wishes to connect his mobile device 5, which is to be used for maintenance purposes, to the controller 3.

For this purpose, he connects his mobile device 5 via a line or wirelessly with the controller 3 or the local network of the passenger transport system in which this controller 3 is integrated.

After this connection has been established and has been signaled, for example, by a suitable message on a display of the mobile device 5, the technician can begin to activate the protected data communication connection 15, for example by selecting a button on his mobile device 5 or making an input in another way.

Based on this selection or this command, the mobile device 5 outputs a type of telegram which contains a randomly generated token 19 and which is transmitted to the controller 3. This initial exchange of data in the form of a negotiation does not yet need to be protected.

The controller 5 then confirms the receipt of the token 19 to the mobile device 5, for example by means of a further special telegram. Furthermore, the controller 5 requests information relating to pairing (“pairing information”) from the external computer 7, to which it is connected via the protected data communication connection 9, adding the generated token 19 to the request.

Upon receipt of the confirmation from the controller 3, the mobile device 5 also requests a pairing key from the data cloud 17 with the external computer 7 and uses the same generated token 19. The request is transmitted via the protected data communication connection 11.

When the common external computer 7 receives the two requests, it generates two asymmetrical key pairs 29, 31, each of which contains a public key 25, 27 and a private key 21, 23, for the controller 3 on the one hand and for the mobile device 5 on the other.

The external computer 7 then transmits the private key 21 of a first key pair 29 and the public key 27 of a second key pair 31 to the controller 3. Analogously, the external computer 7 transmits the private key 23 of the second key pair 31 and the public key 25 of the first key pair 29 to the mobile device 5.

As soon as the key pairs 29, 31 have been delivered, the controller 3 and the mobile device 5 can negotiate a symmetrical key (“session symmetric key”) valid for the following transmission process using encrypted and preferably digitally signed messages.

As soon as this step has been completed, the protected data communication connection 15 is established between the controller 3 and the mobile device 5 and both devices can communicate in a protected manner using the encryption enabled.

Finally, a method is described, for comparison purposes only and not falling under the invention, by means of which data communication between devices in a passenger transport system (described below using the example of an elevator) can be established and, in particular, a secure data connection can be ensured.

An elevator control system generally consists of a set of control units that communicate with one another on a local network. Added to this elevator network, one or more external devices can also communicate with the control system as so-called clients. Examples of such external devices are distribution units, visualization computers, diagnostic units, etc.

In the communication of embedded units, with the spread of the Internet protocol, it has become increasingly important to guarantee adequate communication security. In particular, it is important to guarantee that only authenticated units can connect to a controller in the network.

In the case of a network of elevator controllers, the following influencing factors come into play:
1) The controllers are permanently installed, typically in a machine room.
2) They need to be able to communicate with each other, but there is no guarantee that they will be connected to other devices outside of the network.
3) They are the core of an elevator system. Protection against unauthorized connections to the controllers must therefore be guaranteed.
4) The keys and credentials that are used to authenticate controllers or other clients must all be different from one another in order to avoid global consequences in the event that one of these keys or credentials no longer remains secret (i.e. is “leaked”).
5) In view of point (2) above, the credentials (certificates) should not expire, as acquiring new credentials before such an expiration could prove impossible or involve considerable logistical effort.

A manual pairing mechanism is conceivable which attempts to address all of the points and limitations mentioned above and which is based on the following procedure:
1.) All controllers (and additional clients) are shipped with an additional set of credentials that are not yet shared with the other members of the network. These credentials are randomly generated internally, for example after the controller or the client is started for the first time (boot-up).
2.) Due to point (1.), an initial connection between the members of the network is rejected because of the unknown credentials.
3.) Each member of the network is uniquely identified, for example by a character sequence (string) which is standardized within a product line and is defined in the installation instructions for field use.
4.) Due to the initial (unsuccessful) attempt to integrate a particular controller, the character string of the requesting unit is stored in the volatile memory of the controller which was attempted to be reached.
5.) The list of all requesting units can be output, for example, on an embedded man-machine interface (service MMI) or on an already authenticated local computer-based service tool.
6.) A technician can browse the list of requesting units and approve manually requesting clients, which are identified by their particular character string. For this purpose, the technician can, for example, use suitably edited field instructions to check that names are compatible with the documentation.
7.) During this browsing, the technician can decide to manually select each recognized member and manually approve communication with the controller. Alternatively, all requesting units can be approved by, for example, a “select all” button being pressed.
8.) After approval, the requesting unit is automatically added to the list of trustworthy members and data communication with this controller can take place in a secure manner.
9.) The preceding procedure must be repeated for all the requesting units in the list to be browsed and for each controller in the network.
10.) At the end of the procedure, all credentials are known to all members of the network and communication can be carried out securely.
11.) Connection requests from a unit whose credentials have not been approved are rejected.

The approach described above has the following advantages:
a) The trusted network between the members of the network is created manually under the supervision of an authorized technician.
b) It is carried out locally at the time of commissioning. Therefore, no additional logistical effort (for example during production) is required.
c) It only needs to be carried out once during the installation, as long as no new members are added or are used as replacements for defective old members, for example.
d) There is no manual handling of keys or logistics of credentials. Unique credentials are automatically transferred between the members of the network based on a simple manual approval of a unit or a unit name, for example on an MMI. The field technician can remain completely ignorant of the type and form of such credentials or keys.
e) The method is simple. It requires only selection and approval, for example on an MMI.
f) The method allows the implementation of special notifications, for example on the MMI, in the event of incomplete or missing pair formation.

Finally, it should be noted that terms such as “comprising,” “having,” etc. do not preclude other elements or steps and terms such as “a” or “an” do not preclude a plurality. Furthermore, it should be noted that features or steps that have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-10. (canceled)

11. A method for establishing a protected data communication connection between a controller of a passenger transport system and a mobile device, wherein the controller and the mobile device are configured to establish an initially unprotected data communication connection with one another and to each establish a protected data communication connection with a common external computer, the method comprising the steps of:
establishing an unprotected data communication connection between the controller and the mobile device;
establishing a first protected data communication connection between the controller and the common external computer and establishing a second protected data communication connection between the mobile device and the common external computer;
transmitting a token between the controller and the mobile device via the unprotected data communication connection;
transmitting the token from the controller to the common external computer via the first protected data communication connection and transmitting the token from the mobile device to the common external computer via the second protected data communication connection;
generating in the common external computer a first key pair and a second key pair, each of the key pairs including a public key and a private key;
transmitting from the common external computer the private key of the first key pair and the public key of the second key pair to the controller and transmitting from the common external computer the private key of the second key pair and the public key of the first key pair to the mobile device; and
converting the unprotected data communication connection between the controller and the mobile device into a protected data communication connection by encrypting data to be transmitted using the key pairs.

12. The method according to claim 11 including generating the key pairs in the external common computer in response to the transmission of the token.

13. The method according to claim 11 wherein the external common computer generates the key pairs randomly.

14. The method according to claim 11 wherein the key pairs have a defined expiration time, after which time they can no longer be used for the protected data communication connection between the controller and the mobile device.

15. The method according to claim 11 wherein the common external computer is part of a data cloud hosted by a company in charge of the passenger transport system.

16. A device arrangement for servicing a passenger transport system, the device arrangement comprising:
a controller of the passenger transport system;
a mobile device;
a common external computer; and
wherein the device arrangement is adapted to perform the method according to claim 11 to enable the passenger transport system to be serviced.

17. A controller of a passenger transport system adapted to carry out or control the method according to claim 11 in cooperation with a mobile device and a common external computer.

18. A computer program product including computer-readable instructions that, when executed on at least one processor in a device arrangement having a controller of a passenger transport system, a mobile device and a common external computer, instruct the device arrangement to carry out or control the method according to claim 11.

19. A non-transitory computer-readable medium having the computer program product according to claim 18 stored thereon.

20. A computer program product including computer-readable instructions that, when executed on at least one processor in a controller of a passenger transport system, instruct to the controller to carry out or control the method according to claim 11 in cooperation with a mobile device and a common external computer.

21. A non-transitory computer-readable medium having the computer program product according to claim 20 stored thereon.
